(19) United States
(12) Patent Application Publication
(10) Pub. No.: US 2008/0219416 A1
(43) Pub. Date: Sep. 11, 2008

(54) METHOD AND SYSTEM FOR OBTAINING FEEDBACK FROM AT LEAST ONE RECIPIENT VIA A TELECOMMUNICATION NETWORK

(76) Inventor: John ROUJINSKY, Netanya (IL)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/031,994

(22) Filed: Feb. 15, 2008

Related U.S. Application Data
(63) Continuation of application No. PCT/IL06/00931, filed on Aug. 10, 2006.

(30) Foreign Application Priority Data
Aug. 15, 2005 (IL) 170279

(51) Int. Cl. H04M 11/00

(52) U.S. Cl. 379/88.13

(57) ABSTRACT

A system for obtaining feedback from at least one recipient via a telecommunication network, includes a communication device having a messaging client in bi-directional communication with a messaging serve for receiving one or more events relating to a recipient receiving or responding to a media message sent by a communication device. A Group Management Server stores definitions and properties of registered users and user groups of the system, and a templates server stores message templates for access by communication devices connected thereto.

### FIELD OF THE INVENTION

This invention relates generally to voice messaging and particularly to multimedia messaging having a voice component.

### BACKGROUND OF THE INVENTION

Mobile Decisions developed by Netalizer, Inc. of Tel Aviv, Israel allows text based information to be communicated via the cellular network to multiple end devices using WAP. A particular application of Mobile Decisions provides recipients with a text-based menu providing different voting options that may be selected using the scrolling features of the end device. The user responses are stored by a central server that may be adapted to perform statistical analysis on the user responses and convey the results to the users' end devices or web interface.

Conveying text messages and responding to questionnaires and surveys using Mobile Decisions requires manual operation of the telephone interface. This is time-consuming, and in the ever-increasing drive to render mobile telephones smaller it is cumbersome and prone to error. Moreover, it may not always be convenient or even safe, particularly in those situations where the user requires use of both hands for other purposes, such as driving. But even apart from this, text-based interfaces require literary and technical proficiency that may be beyond the capabilities of some users. Clearly, such problems would be avoided if the menus were voice driven rather than text-based.

Voice activated menu systems are known in the patent literature. For example, U.S. Pat. No. 4,451,700 (Kempner et al.) published May 29, 1984 discloses a telephone based automatic audience survey system for polling an audience to obtain data representative of the opinion regarding a question of interest. Incoming calls are answered with an analog voice signal that both identifies the telephone based automatic audience survey system and queries a response in regard to the question of interest. In response to the answers provided to the query portions of the analog voice signal, data representative of the consensus regarding the question of interest is provided and displayed in real-time.

US 2004/0234065A1 (Anderson) published Nov. 25, 2004 discloses an automated telemarketing method for computer-based interactive speech application, where information is conveyed to customer upon sending greeting and upon receiving a message from the customer. A telephone call is initiated to a potential customer using an auto-dialing device and a voice platform is notified that the potential customer has answered the telephone call. The voice platform includes a text-to-speech device and a speech recognition device. In response to receiving the notification, a verbal greeting provided by the text-to-speech device is sent to the potential customer. The method further comprises conversing with the potential customer via the voice platform in response to sending the verbal greeting. The conversing includes receiving a message from the potential customer via the speech recognition device. Information is provided to the potential customer responsive to the message.

WO 0041415A1 (Isotalo) published Jul. 13, 2000 describes a method for implementing a voting service by means of a mobile telephone, in which the vote cast by the mobile phone subscriber is sent using a digital telephone as a short message over radio networks. Confirmation of the casting of the vote is also sent as a short message.

US 2003/0100321A1 (Rao et al.) published May 29, 2003 and entitled “Instantaneous polling utilizing a message service mobile phone network” discloses a polling system for voting, auction bidding, opinion surveying, and the like, communicable with mobile communications devices for performing information collection responsive to input from the mobile communications devices, utilizing an existing short message service (SMS) and/or Internet wireless applications protocol (WAP), and information processing means for processing and analyzing the information collected. The collected information is stored, organized, analyzed, and transmitted to the mobile communication devices using SMS, or through the Internet using WAP, or to Internet-connected devices of any kind.

EP1450570A1 published Aug. 25, 2004 to Lucent Technologies Inc. and entitled “Communication to one mobile station of update of call participation availability status of another mobile station” discloses an application server component of an apparatus that comprises a buddy list service that monitors a status (e.g., online, offline, busy, on a call) of mobile stations to determine whether they are available for participation in a call.

It would clearly be desirable to provide a system allowing questionnaires and surveys to be effected using mobile telephones that allow both prompts and responses to contain media content other than text alone.

### SUMMARY OF THE INVENTION

It is an object of the invention to provide a method and system allowing questionnaires and surveys to be effected using mobile telephones that allow both prompts and responses to contain media content other than text alone. Within the context of the following description and the appended claims, such a message will be referred to as a “media message”. It is therefore to be understood that within the context of the invention and claims the term “media” can refer to any message such as voice, video etc. and can also be a multimedia message integrating different types of media.

This object is realized in accordance with a first aspect of the invention by a method for obtaining feedback from at least one recipient via a telecommunication network, the method comprising:

compiling a media message using a sending device;

sending the media message to a server for storing together with a respective identity of each recipient; and

receiving one or more events relating to a recipient receiving or responding to said media message.

In accordance with one embodiment of the invention, such a method is carried out by end-user device using the service to send a voice message to one or more recipients. In a typical implementation, after sending the voice message, the sender receives acknowledgement from the server that the voice message has been received. The events may relate simply to the fact that a recipient has opened an incoming message; or it may be that he or she has responded and the answer is thus stored at the server for access by the sender. Likewise, the events may be pushed by the server to the sender; or the sender may actively request updates by accessing the server.

In accordance with another aspect of the invention, there is provided a method for obtaining feedback from at least one recipient via a telecommunication network, the method comprising:

receiving from a sender device message data indicative of a recorded message that a sender device wishes to convey to a recipient device;

storing said message data together with a respective identity of each recipient device;

conveying data to each recipient device pertaining to said message data;

storing events relating to an activity performed by a recipient device on receiving or responding to said data;

analyzing said events so as to generate status data; and

storing the status data for access by the sender.

In accordance with one embodiment of the invention, such a method is typically carried out by a server operating the service to receive a voice message sent by a sender, to convey the voice message to one or more recipients and to receive and process their responses. The server typically operates an inbox for each recipient and, upon receiving a response (i.e. event) stores pertinent data in the corresponding recipient's inbox. Data pertaining to each message could be notification of an awaiting message or could be the message itself. Storing the status data for access by the sender is the default for one-to-many; but the status data could be sent directly to the sender.

It should however be noted that the advantages of the invention derive not only from the ease of recording voice messages in preference to typing text messages, but also from the greater convenience of listening to a message for many users. Many of these advantages can be realized using other forms of multimedia beside, or in addition to, voice. For example, messages may be audio-video clips that may be conveyed independent of regular voice messages or may accompany such messages. For example, a voice message may prompt the recipients to provide feedback concerning a set of options that are displayed visually on an accompanying video clip. In such case, the prompt itself remains vocal and the multimedia adds content. But the invention embraces also the possibility that a multimedia message is formulated by the sender and then conveyed to selected recipients. Such multimedia messages will typically include voice, but not necessarily so.

### BRIEF DESCRIPTION OF THE DRAWINGS

In order to understand the invention and to see how it may be carried out in practice, an embodiment will now be described with regard to audio messages, by way of non-limiting example only, with reference to the accompanying drawings, in which:

FIGS. 1 and 2 show pictorially representations of communication systems that allow a source telephone to convey audio-messages to multiple receiving devices and to receive feedback according to a non-limiting embodiment;

FIG. 3 schematically shows a client-server system suitable for implementing another non-limiting embodiment;

FIG. 4 is a block diagram showing functionally an enhanced telephone adapted to convey an audio message to at least one receiving device;

FIG. 5 is a block diagram showing functionally a messaging server adapted to receive an audio message, convey it to multiple recipients, and process and feed back received responses;

FIGS. 6a and 6b are pictorial flow charts showing operation of the system according to an embodiment of the invention; and

FIGS. 7a and 7b are a sequence diagram showing the principal dialog between two telephones operating in accordance with an embodiment of the invention; and

FIG. 7c shows a detail of the sequence diagram shown in FIGS. 7a and 7b depicting an alternative embodiment relating to statistics flow between the sender and the server.

### DETAILED DESCRIPTION OF EMBODIMENTS

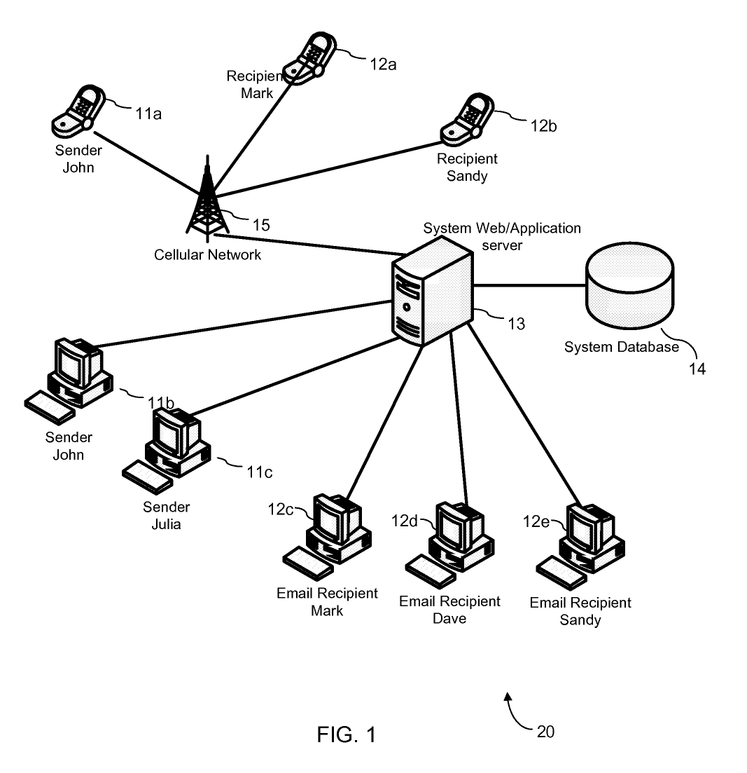

FIG. 1 shows pictorially a system 10 according to an embodiment for conveying audio messages from one or more sender devices 11a, 11b, 11c to one or more receiving devices 12a, 12b, 12c and receiving feedback via an application server 13, which stores messages and feedback in a database 14. As shown, the devices 11a, 12a and 12b are mobile telephones coupled to each other and to the application server 13 via the Cellular Network 15. The devices 11b, 11c, 12c, 12d and 12e are computers that are interconnected via the Internet to the application server 13. In such a system, a sender, John, can send a voice message via the mobile telephone 11a to a recipient, Mark, using the mobile telephone 12a. Likewise, senders can use either telephones or computers to send messages. In the latter case, the web interface of the application server 13 is used. Even if a sender has sent the message using a telephone, statistics can be seen using computer and vice versa. Recipients can receive messages either to phone or computer, in the latter case use of e-mail being most likely. Thus, as shown by way of illustration in the figure, recipients, Mark, Dave and Sandy receive e-mail messages at their respective computers 12c, 12d and 12e in response to vocal messages communicated by any of the senders using mobile a telephone 11a or computers 11b, 11c.

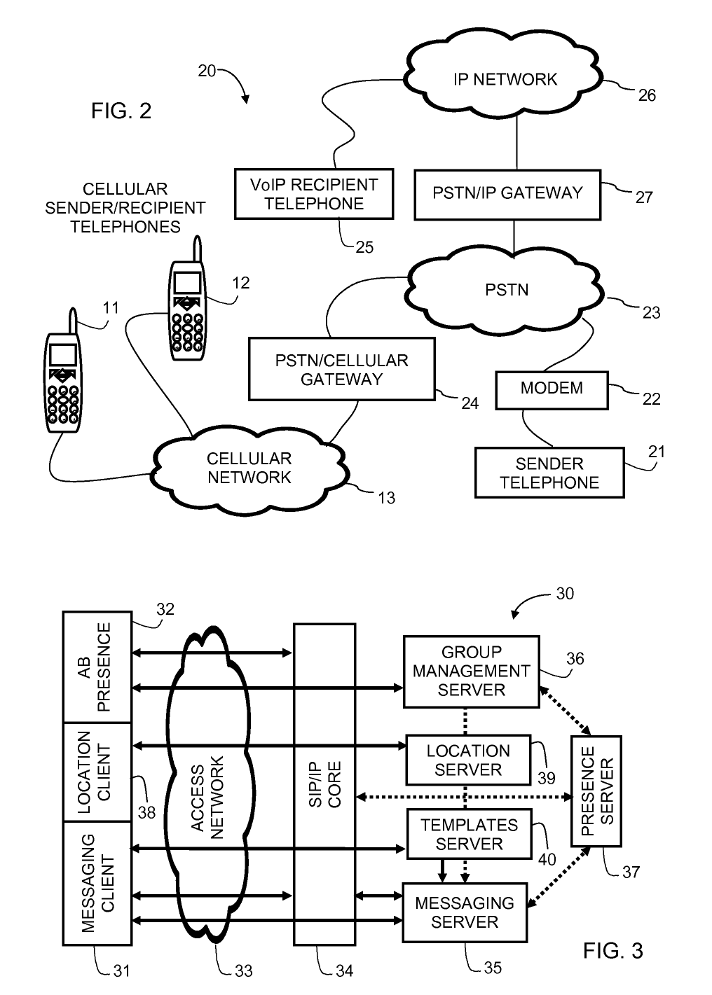

FIG. 2 is a pictorial representation of a hybrid system 20 for conveying audio messages between a sender cellular telephone 11a and a recipient mobile telephone 12a connected to the cellular network 15. Additionally, a smart PSTN telephone 21 connected to the PSTN 22 via a modem 23 may also serve as a sender telephone, in which case the PSTN 22 serves as a conduit to the cellular network 13 via a PSTN/Cellular gateway 24. A VoIP telephone 25 may serve as either a sender or recipient and is coupled to an IP network 26 that is connected to the PSTN 23 via a PSTN/IP gateway 27. The only substantive difference between the system 10 shown in FIG. 1 and the hybrid system 20 shown in FIG. 2 is that in the system 20 signaling and media are conveyed from one network to the other via the PSTN/Cellular gateway 24 or the PSTN/IP gateway 27, which operate in a manner well known in the art to convert the signals between PSTN and IP or PSTN and Cellular protocols and vice versa.

By way of example, so far as the IP network 26 is concerned, the PSTN/IP gateway 27 functions as an intermediate recipient that receives signaling and media from the sender telephone 21. In the IP network 2-6, the signaling and media are received together by the PSTN/IP gateway 27 on the same path and allow connection to the VoIP recipient telephone 25. An audio, and optionally, video stream conveyed by the sender telephone 21 is directed by the PSTN 23 to the PSTN/IP gateway 27, which in turn determines that the required destination is either the cellular recipient telephone 12 in the cellular network 13 or the VoIP recipient telephone 24 in the IP network 26. If the recipient is the cellular telephone 12, the message reaches the PSTN/Cellular gateway 24, which determines that the destination address is a telephone in the cellular network 15. If the recipient is the VoIP recipient telephone 24, the PSTN/IP gateway 27 receives the signaling and media on separate paths in the PSTN 23, performs the required protocol conversion, and re-directs the signaling and media on a common path in the IP network 26 to the recipient telephone. The PSTN/IP gateway 27 converts IP network instant messages to the necessary format for PSTN. Thus, the invention allows audio messaging in real time within the cellular network or between the cellular network and the IP network or the PSTN as well as allowing streaming functionality between the PSTN and the other two networks.

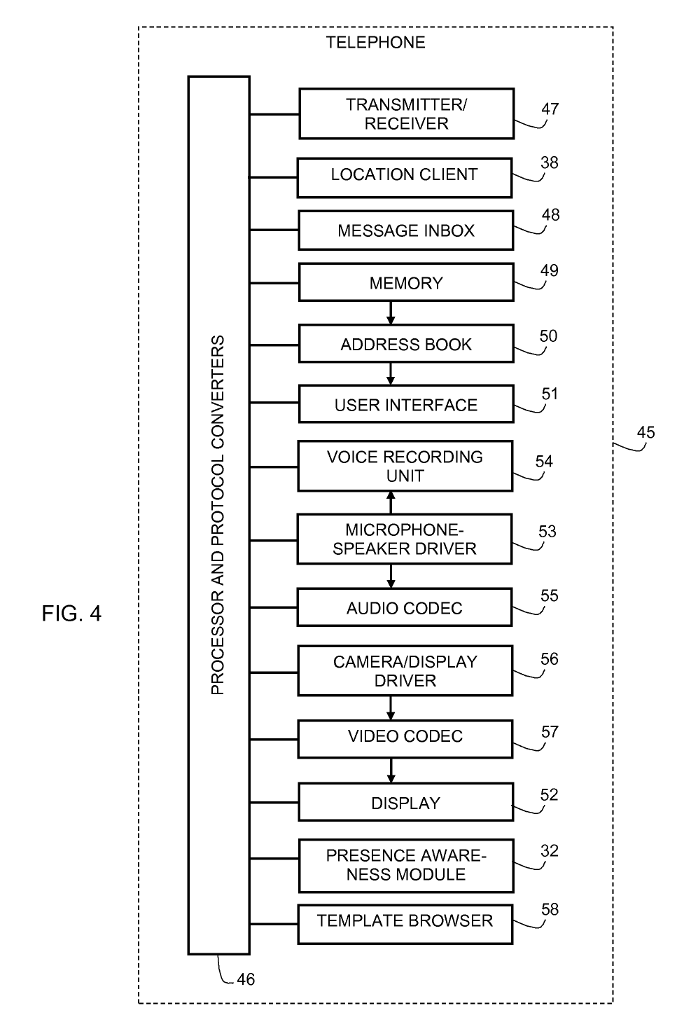

FIG. 3 schematically shows a client-server system 30 suitable for carrying out a non-limiting embodiment of the invention. The system 30 includes a messaging client 31 having an optional AB presence unit 32 that are loaded into a sending or receiving device shown as 45 in FIG. 4. The messaging client 31 is coupled via an access network 33 to a SIP/IP core 34 (constituting a protocol handler) and thence to a messaging server 35, thus allowing bi-directional communication between the messaging client 31 and the messaging server 35. The AB presence unit 32, if provided, is likewise coupled to the SIP/IP core 34 and thence to a Group Management Server 36. The Group Management Server 36 stores definitions and properties of registered users and user groups of the system, such as ID, address, Group ID etc. This allows a sender device to access such properties thus facilitating contact and group access and management remotely. Optionally, a presence server 37 coupled to the SIP/IP core 34 and to the messaging server 35 and the Group Management Server 36 may also be provided. Optionally a location client 38 may be provided in the sending or receiving device 45 for operating in conjunction with a location server 39 for allowing the location server 39 to compile a list showing the location of each device. As will be explained later, this allows recipient profiles or classifications to be location-dependent so that messages can be sent to recipients whose location is within prescribed limits. For example, a taxi dispatcher wishing to direct taxis to a client can use this information to send the order only to those taxis that are located within a prescribed radius of the client's location. A templates server 40 allows message templates to be stored centrally for access by the sending devices connected thereto. As will be explained later, templates are standard message objects that may include voice, text and other media and optionally designated recipients, thus allowing commonly used messages to be pre-formatted and saving time. Although in FIG. 3 the messaging server 35, the Group Management Server 36, the location server 39 and the templates server 40 are shown as separate, distributed components, it will be appreciated that they can be realized by a single server. Likewise, any or all of these servers can be realized by distributed servers, as is well known in the art.

The system 30 may be implemented in any IP network, e.g., cellular, Wireless LAN, wireline IP based connection, Modem connection and over any bearer—PSTN, PLMN, etc. The messaging client 31 can run on different devices such as mobile phones, smart phones, WDAs PDAs, etc. and be implemented in variety of technologies, for example Java, J2ME, Brew, Symbian, Linux, Windows, PocketPC, SmartPhone, PalmOS, or others. Java and J2ME are trademarks of Sun Microsystems Inc., Brew is a registered trademark of Qualcomm Inc., San Diego, USA. Symbian is a trademark of Symbian Software Limited, London, UK. “Linux” is a registered trademark of Linus Torvalds, the original author of the Linux kernel. Windows, PocketPC, and SmartPhone, are registered trademarks of Microsoft Corporation, Redmond, USA. PalmOS is a registered trademark of PalmSource, Inc. and its licensor, Palm Trademark Holding Company LLC. The client-server system 30 can utilize variety of protocols for notification/message loading/sending answers. Thus, with the current state of art for cellular networks, the following is expected to be used:
iDEN or other ‘always on’ networks:
   N Notification: UDP/SMS
   The rest: HTTP/Socket
GPRS/CDMA
   Notification: SMS
   The rest: HTTP/Socket

The AB presence unit 32 is a client that connects to the presence server 37 to provide presence and service identification data. The messaging client 31 does not obtain this data directly from the presence server but rather takes data provided by the presence client (the AB presence unit 32) and uses this data to update the presence data and the service information received from the network. If the presence information (information about the properties of potential recipient devices) is not required, then both the AB presence unit 32 and the presence server 37 may be dispensed with. Otherwise, both the AB presence unit 32 and the presence server 37 are needed.

FIG. 4 is a block diagram showing the functionality of an enhanced telephone 45 (constituting a communication device) according to the non-limiting embodiment that may serve as either a sender or receiving device. In this depicted example, the telephone 45 is a cellular telephone that is enhanced by a software client. The telephone 45 has a processor and protocol converters shown generally as 46. A transmitter/receiver 47 allows cellular transmissions and receptions in a known manner. The location client 38 described above with reference to FIG. 3 optionally operates in conjunction with the location server 39 to include the sender's location within the message. In the absence of the location client 38 and/or the location server 39, this may be done manually by the sender. A message inbox 48 provides a view of a subscriber inbox for each recipient on the messaging server, including limited local storage of incoming messages, downloaded from the server. A memory 49 stores data such as an address book 50 and optionally sender/recipient profiles and a user interface 51 allows respective telephone numbers of one or more recipient addresses to be selected for conveying voice and/or video streaming thereto. Address book function allows use of phone's contact list or contacts and groups managed by the system, either on the phone or on the system's server. Typically, the user interface 51 includes a keypad and scrolling keys for typing text messages and selecting options displayed on a display 52.

The enhanced telephone 45 also has a microphone/speaker driver 53 that allows speech to be converted to electrical signals for recording using a voice recording unit 54 and which may be encoded by an audio codec 55 for producing an audio stream in a known manner. By virtue of the microphone/speaker driver 53, a message can be played immediately and loudly using a loudspeaker of the phone, regardless of the phone's settings before the reception of the message, so no manual intervention is required at all. The voice recording unit 54 includes a conventional user interface that provides play/record and forward/backward rewind facilities. A recorded message is stored in the memory 49 and may be edited before sending. Likewise, a camera/display driver 56 allows a video image to be captured and is coupled to a video codec 57 that converts it to a video stream in a known manner. The presence awareness module 32 allows the user to determine at a glance whether a receiving device is on-line and available for receiving a message. Presence awareness is functionally similar to a buddy list, such as the one described in EP 1450570A1, allowing, for example, the status of members thereof to be displayed using suitable icons. The status may also indicate whether a receiving device associated with a selected member is an enhanced device or is a simple device. This information may be used to avoid the sender inadvertently trying to send video messages to a receiving device that is flagged as being incapable of video messaging. It is also used to inform the server of device capabilities so that the server knows which protocol to use, which data format etc. for each recipient device. By such means, if the sender sends a video message to multiple recipient devices, some of which do not have video capability, the server is able to convey the full messages to those recipient devices that have video capability, while removing message components that are not supported by other recipient devices. A template browser 58 operates in conjunction with the templates server 40, shown in FIG. 3, for accessing templates and optionally allowing templates to be downloaded from the templates server 40. This obviates the need for local storage, although it will be understood that limited local storage of most commonly required templates may also be provided.

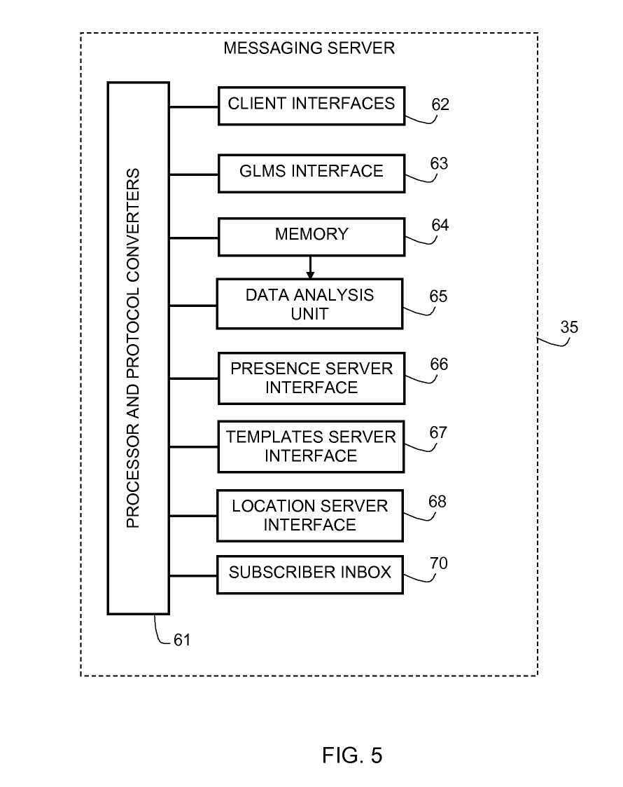

FIG. 5 is a block diagram showing the functionality of the messaging server 35 shown in FIG. 3 being adapted to handle messaging between a sender device and a receiving device according to a non-limiting embodiment of the present invention. The messaging server 35 has a processor and protocol converters shown generally as 61. Furthermore, the messaging server 35 has client interfaces 62 that are coupled to the processor 61 and serve as first and second interfaces for coupling to respective first and second telephone devices. Both of the telephone devices have a display and a voice recording/play unit as explained above. A GLMS interface 63 allows groups to be defined so that an incoming call directed to one member of the group may be automatically sent to the other members of the group. Accordingly, multicast transmissions may be conveyed to several parties simultaneously. A memory 64 stores message data and possibly icons or other image data of registered users.

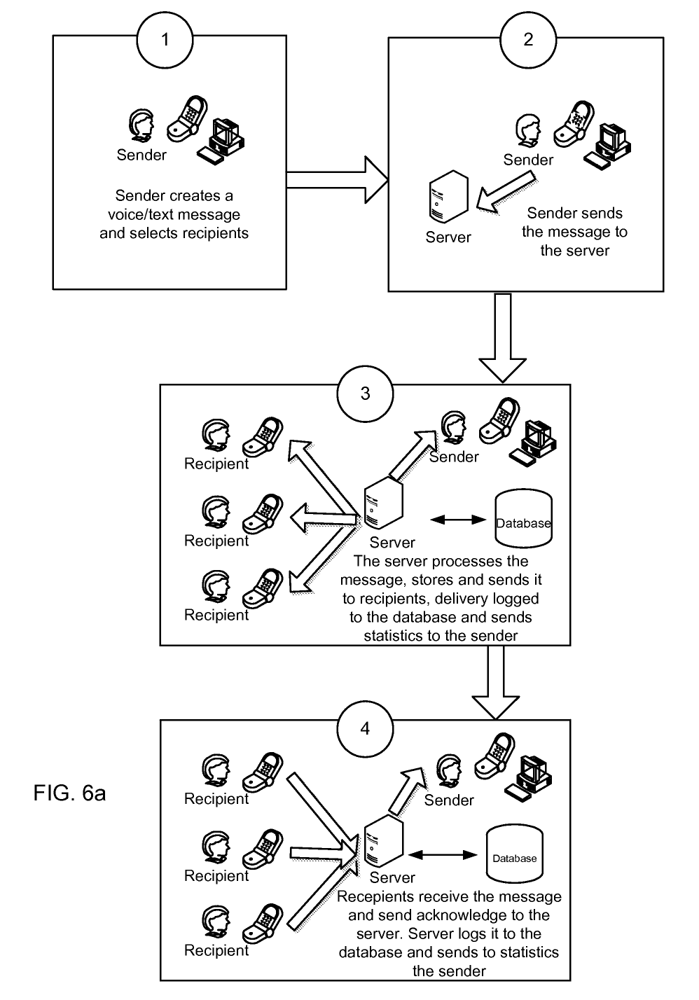

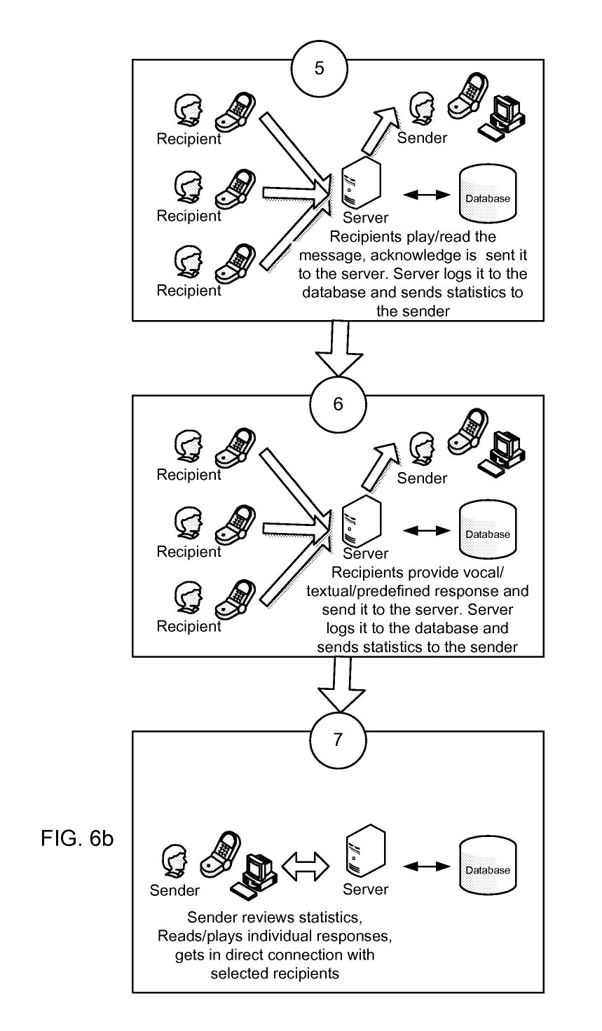

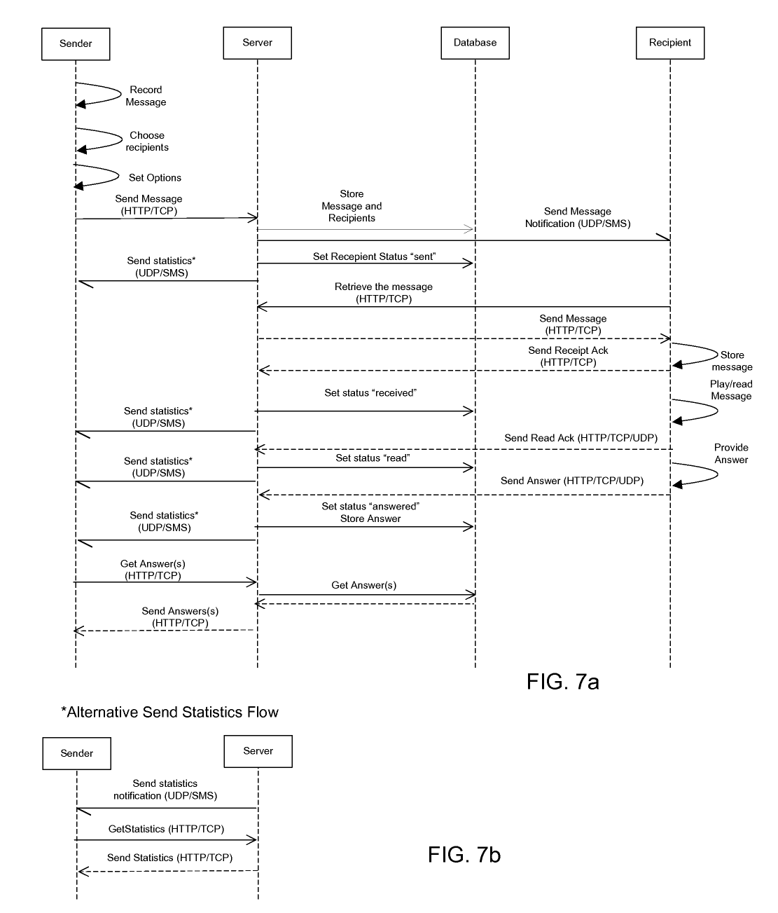

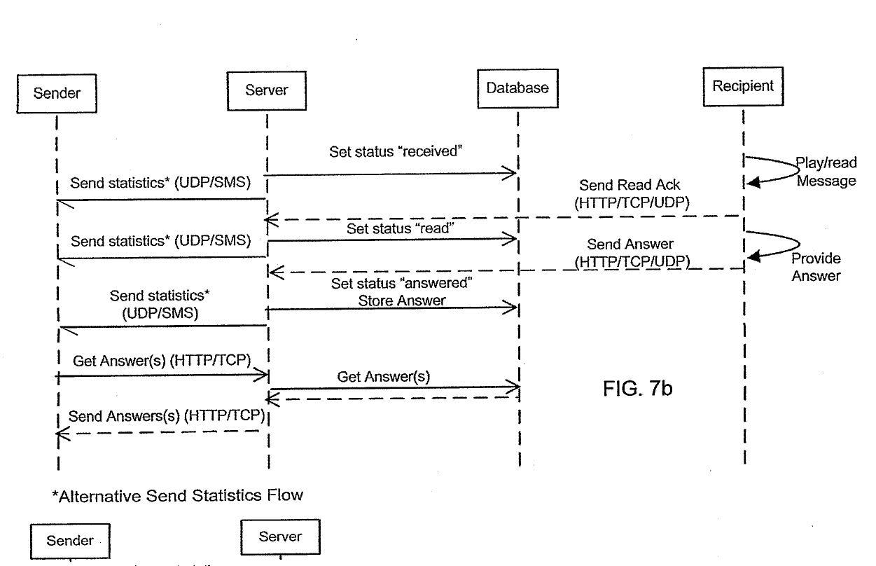

The messaging server 35 further has a data analysis unit 65 that is adapted to process data received from recipient device in response to messages conveyed thereto by a sender device. This allows events to be logged and statistics to be compiled, as explained in greater detail below with reference to FIGS. 6a, 6b and 7 of the drawings, and conveyed to the sending device for vocalization and/or display thereby. A presence server interface 66 allows connection of the optional presence server 37 as described above with reference to FIG. 3. A templates server interface 67 allows connection of the templates server 40 as described above with reference to FIG. 3. A location server interface 68 allows connection of the location server 39 as described above with reference to FIG. 3. The messaging server 35 also provides storage for a plurality of subscriber inboxes each in respect of a different registered subscriber, providing storage of messages even when the designated recipients are off-line and allowing subscribers to access and browse messages whenever it becomes convenient.

FIGS. 5a and 5b are pictorial flow charts showing operation of the system according to an embodiment of the invention. The sender creates a voice/text message and selects those recipients to whom he wishes to send the message. The message and destination data are sent from the sender 11 to the server 13, which processes and stores the message, and sends it to the recipients 12. The server 13 logs delivery to the database 14, analyzes the feedback events and conveys statistics to the sender. Statistics at this stage would include: total number of recipients, the number of recipients to whom the message has been sent, and the number of recipients to whom the message has not yet been sent yet. Recipients receive the message and send acknowledge signals to the server 13, which the server 13 logs to the database 14. The server 13 analyzes the acknowledge signals so as to compile statistics regarding which recipients have received the message, logs statistics to the database 14 and sends them to the sender 11. Recipients 12 opening the message to play or read it, send an acknowledge signal to the server 13, which analyzes the acknowledge signals so as to compile statistics regarding which recipients have opened the message, logs statistics to the database 14 and sends them to the sender 11. The sender may review the statistics, read or play individual responses and make direct contact with selected recipients. Recipients may likewise make predefined vocal or textual responses, which are conveyed to the server, which logs statistics to the database 14 and sends them to the sender 11.

Notification of an awaiting message may be communicated to a recipient in a variety of different ways, such as vocally or visually as is known in the art. For example, a beep or a pre-recorded voice file may be vocalized or a vibration signal may be produced. Additionally, or alternatively, if the recipient device is suitably enabled, visual notification may be given, such as a picture of the sender or another image or an icon depicting a message category, for example. The notification message, in whatever form it is given, may remain either for a fixed time period or until the recipient responds or acknowledges receipt. The recipient may play the message or activate a snooze function, which causes the message to remain dormant for a fixed time period.

The notification message may be configured to provide different levels of information according to system setup or based on user-selected options. At its most basic, no information may be provided other than the actual fact that a message has arrived. In this case, the recipient has to retrieve the message even if he/she only wants to know who the sender is. Alternatively, the notification may include details of the sender, such as name, phone number, picture etc. Details may be shown textually or may be vocalized.

Upon playing a message, answers may be given in a variety of ways. For example, a limited number of options may be enumerated 0 through 9, thus allowing a recipient to select a desired option by pressing the appropriate numeric key. When a message is displayed visually, scrolling options may be provided assuming the receiving device has a suitable interface, in the same way that many mobile telephones allow selection of a desired contact from an address book. A less sophisticated approach is to vocalize each option in turn and interpret a key press as an acceptance of the most recently vocalized option.

The recipient can send a voice reply in addition to the above options or instead of choosing predefined option or providing textual/numeric answer (if allowed by sender) or, if he chooses, he can call the sender. Awaiting messages can be accorded different priorities according to settings that are defined for each recipient. According to different implementations, the priorities can be set by the recipient locally or a user profile for each recipient can be set and stored at the server. Thus, messages may be set so as not to played immediately, or if not responded within predefined period of time, to be played a specified number of times. Alternatively, messages may be set so as to be played immediately. The profile may be varied according to the sender so that messages from low priority senders are merely notified, while messages from high priority senders, who could be individuals or groups, such as spouse, boss, emergency services etc. are played immediately. Likewise, the messages themselves may be categorized so that messages of a specific category like “urgent” are played immediately. The profile can be set to remind the recipient of unread messages at predefined time intervals. A user interface is provided to allow recipients to delete one or more messages and to view messages according to sender, time, or category; to save the sender in an address book and to forward a message to someone else.

The voice recording unit 39 is used to record and play a message. Recording can be interrupted in the middle and continued later, restarted or aborted. Optionally, responses received vocally can also be recorded using one voice chunk for each answer. The voice recording unit 39 can be adapted to compile messages of predetermined types that are processed differently. According to an embodiment, on recording a message, the sender may set the message definition to one of the following:
Info—no answer required
Open—numeric/textual/voice/multimedia answer is required
Select—selection of one of a number of predefined options is required.

The sender may also indicate whether the message includes answers and, if so, he may:
Define number of answers in the message
Define whether voice answer is allowed/required
Define whether voice answer only is allowed
Define whether recipient receives information about the message in notification, or has to download the message.
Add Digital Sound Processing (DSP) effects to the message with ability to preview the processed message. Digital Sound Processing allows sound effects used in the music industry, like “echo”, “compressor”, “limiter”, “overdrive”, “distortion”, “vocoder” etc. to be added, and to modify pitch or speed of the recorded message.

In addition to a vocal recording, a message may also include text, in which case the sender may:
Enter message text (optional)
Enter text for each option of predefined answer
Optional client based template for text. Such templates allow for textual entry and include widely used questions, like “Would you call me please?” “Are you coming to . . . ?” etc. This save time by allowing selection and possibly customization of an appropriate template instead of typing the text in full.

The user interface 36 allows the sender to choose recipients by list selection, by alphabet, by categories (e.g. family, friends, work), by phone number, and private number and allows a Voice Tag to be attached to the message. By “private number” is meant a push-to-talk number (similar to phone number) used in iDEN network. Voice Tags are usually recipient's/sender's name recorded as a voice message, So, for example, when messages arrives, the phone could “say” “you have a message from John”, where John is a voice tag. Recipients may also be selected from phone's contacts, favorites, recently used recipients, groups list, groups recently used, “Speed Dial”, by entering phone number(s), and by Location/Presence information (e.g. “everybody located in radius of X meters from me”, or “everybody who is on-line now”). The sender may select whether to send only to phone or other addresses (email, PDA etc) as well. He may also have the option to send MMS if the client application according to the invention is not available on the recipient device. He can prioritize a message to choose if message will be forced to play or not and to select how many times to play. A “speed dial” facility is provided to map some users/groups/send templates. A user can assign a pre-defined user/group or template to a phone button. Pressing this button associates the respective user or group to a message and instantly sends it, all with a single action. Alternatively, a pre-recorded message template can be mapped to the phone button. In such case, pressing the button requires the user to specify one or more recipients, which can also be done by depressing a button to which the desired recipient(s) is/are mapped.

Templates allow standard messages to be prepared in advance and sent directly, or to be edited and then sent. If a template includes only a message, the recording phase will be skipped. However, templates may also include predefined recipients as well, in which case they will be sent right away. Templates may be stored on the server or on the client. Server templates may also be popular or fashionable voice templates such as funny-sounding widely-used messages/questions. Upon selecting a template, control proceeds to the regular send flow with ability to change some options. Templates are usually created by recording a message in the normal way and saving as a template.

The sender may control the manner in which notifications are sent by the web application server by setting a notification policy that applies for a specific message or template or in respect of specified recipients or groups of recipients. The notification policy may be set to:
Receive notification after each recipient state transition
Receive notification after each recipient answer
Receive notification after all recipients answered+time period
Receive voice notification [for each of 3 above]
Receive statistics each X minutes during Y minutes

Scheduling allows a message to be sent once after a specified time delay or at defined date or time. Alternatively, a message may be sent repeatedly at specified time intervals (like each Monday at 8:00). Also, TTL (time to live) intervals may be defined during which the system will try to deliver the message to recipients and/or will accept recipient answers.

Once messages have been sent, they may be tracked together with any feedback received from the recipients. Sent messages have visual content may be viewed and their audio content may be played. Summary statistics such as total sent messages, number of messages received, number of messages read, and number of messages answered can be displayed. Summary response statistics such as minimum, maximum, sum, average of numeric responses may be shown; and distribution of answers for messages with predefined answers. If voice answers exist, a suitable icon may be displayed, which when pressed causes voice answers to be played. Recipient classification allows different behaviors to be defined for messages coming from a particular category. For example, messages from family may be played immediately. It also allows browsing of messages in inbox per category, thus allowing messages from family or any other selected recipient category to be browsed. Each recipient may be selected for listing his or her respective answer, allowing a desired recipient to be called. All responses and statistics can be displayed visually or vocalized, thus permitting hands-free operation.

Provisioning options facilitate system interaction with users that can be set by sender or recipient or provisioned remotely by a system/customer administrator, this being useful in corporate environment. The system/customer administrator may also specify which options can be modified by the user and whether setting of recipient is overridden by setting in the message or vice versa. Settings include:
Play messages immediately
Play messages loudly using speaker
All other vibration/lighting/sound options as described above in connection with recipient and sender options.
Re-play messages a defined number of times
Allow/disallow stopping message play
Do not send status to the server (“hiding”)
Send predefined voice/text message back if recipient is busy and not able to read/listen to messages (for example, during a meeting).
Forward all incoming messages to a specified phone/email address.

It is possible to specify the above options generally or per recipient/group/category. Remote provisioning of these options might be used in the following cases:
Corporate environment: for example, corporate administrator can disable recipients to set “silent” mode or “hiding” for messages sent by the organization.
Restoring settings of a user when the phone is changed: all the settings are stored on the server and can be replicated when the user's phone is changed.
The system facilitates selling certain features for an additional fee. In such a case, the service operator will enable these options for subscribers remotely.

It also means that if a particular option is set in the message and not at the recipient phone, the message setting takes precedence and vice versa (unless otherwise provisioned by system administrator).

FIGS. 7a and 7b are a sequence diagram showing the principal dialog between two telephones operating in accordance with an embodiment of the invention and showing suitable protocols for conveying messages between different components of the system. As shown, the sender records a message and selects recipients and options. The message is then sent to the messaging server using HTTP/TCP. The server stores the message together with the identities of the recipients in the message database and conveys to each recipient notification that a message has arrived. This may be done using UDP/SMS. As noted above, the message options may define the message as high priority in which case the notification may be omitted and the message will be conveyed directly to the recipient for immediate play. Once the notification or the message itself has been sent, the server sets a recipient status to “sent”, stores the status in the message database and sends statistics to the sender using UDP/SMS.

Upon receiving notification of an awaiting message, the recipient may retrieve the message from the server by sending a request using HTTP/TCP, whereupon the server conveys the message to the recipient also using HTTP/TCP. The recipient acknowledges receipt of the message by sending a receipt acknowledgement signal to the server, also using HTTP/TCP. The server now knows that the message was received and sets the recipient status to “received”, stores the status in the message database and sends statistics to the sender using UDP/SMS.

The recipient can store and/or play the message locally. Upon playing (i.e. reading) the message, the recipient sends a read acknowledgement signal to the server, also using HTTP/TCP. The server now knows that the message was read and sets the recipient status to “read”, stores the status in the message database and sends statistics to the sender using UDP/SMS. When the recipient answers the messages, the answer is sent to the server using HTTP/TCP. The server sets the status to “answered”, stores the status along with the answer in the message database and sends statistics to the sender using UDP/SMS. At this point, the sender can send a query to the server using HTTP/TCP to access the recipient's answer or the respective answers of more than one recipient. The server retrieves the answers from the database and sends them to the sender using HTTP/TCP.

According to an alternative embodiment shown in FIG. 7c, statistics are not sent to the sender whenever the status changes, but rather notification about status change is delivered to the sender. The sender device retrieves statistics from the server in accordance with various behavior options that can be set by the sender. Sender options may also bet set to adjust the frequency of statistics messaging. In this case, the server initiates the communication of statistics to the sender, but rather than doing so whenever recipient status changes, does so at preset time intervals if the status of one or more recipients has changed subsequent to the previous communication of statistics to the sender.

In an embodiment of the invention, the dialog between the sender devices and the recipient devices via the messaging server may be implemented using Session Initiation Protocol (SIP) (the current edge of VoIP Telephony) but one of ordinary skill in the art would readily recognize that any other suitable protocol may be employed.

Although the invention has been described with particular regard to applications that convey simple voice messages, it is to be understood that the invention is not limited to voice-only messages. Thus, messages may include also text, video and other multi-media content and, as noted above, may be messages of a single media type other than text alone.

In the embodiments described above, messages are recorded by the sender at his or her sending device, be it a telephone or computer. However, the invention also contemplates other approaches to compiling messages. For example, the sender can establish streaming or voice communication with the messaging server and dictate messages for direct storage by the messaging server. Alternatively, the messaging server can access a database of standard messages that are sent to recipients in response to a designated event. The event may be a message sent manually by the sender containing a message ID pointing to a message in the database that is to be forwarded to specified recipients. Alternatively, standard messages may be pre-recorded on the recipient device thus allowing a specific message to be played by embedding the appropriate message ID in the message to the recipient. Message playing on the recipient device can be done via streaming or by using voice communication. This scenario can be extended to a case when the receiving handset checks whether a required message already exists on the phone and if not, retrieves it from the server. The message protocol preferably allows the sender to specify that the recipient device should persistently store the message for future use. These options reduce traffic between the sender and the messaging server.

However, even more significantly it allows the invention to be applied to automated messaging systems that do not require human initiation. For example, the sender may be a computer that is responsive to an event for sending a specified message to one or more designated recipients. The event can be a simple event, such as a date or time; or it can be produced by a sensor such as a smoke sensor that detects a fire and automatically alerts a group of fire-fighters; or it can be a composite event determined by a situation awareness program. Composite events also include allow for multiple responses to the same message e.g. first time to acknowledge reception, the second time to acknowledge reading, the third time to acknowledge completion of task.

These features find application in an automatic monitoring system where operator feedback is required. Thus, to take the emergency fire service as an example, a voice message may alert the emergency crew and indicate the location of the fire as determined by the location of the sender device embedded in the message conveyed by the sender. The message may be conveyed to all fire-fighters in a specified group or to the fire-station operator. Upon receipt of the alert signal a first message is automatically conveyed to the system operator showing that the alert was sent. When one or more fire-fighters open the message a second message is conveyed to the system operator. Upon dispatching a crew to the fire, a third message may be conveyed; and upon completion of the task, a fourth message may be conveyed. To this end, the messaging server may be provided with a task module that allows tasks to be compiled for access and display by authorized recipients. Any authorized recipient can open the task screen and select a desired task, e.g. by clicking on the task, for opening a standard message menu allowing a selected message to be associated with the selected task and conveyed to the sender.

The invention further allows message escalation in situations where a designated recipient does not acknowledge the message within a specified amount of time, whereby the system automatically sends it to somebody else and so on. For example, in the fire-fighter scenario this technique may be used to ensure that if the alert is sent to the fire-station operator and is not acknowledged within a specified time limit, it will be forwarded to the next in command and so on until it is acknowledged.

One of ordinary skill in the art will understand that the client and the messaging server may be suitably programmed computers. In this context, it is to be noted that the borderline between portable telephones and computers is becoming increasingly vague since both may be equipped with a processor, memory and internal program as well as interfaces to peripheral equipment, such as a video camera and display, which may be built-in. Therefore, for the purpose of interpreting the attached claims no distinction is implied and it is to be understood that reference to a “portable telephone” and to “telephone” may equally apply to a computer having a suitable communications interface, Likewise, the invention contemplates a computer program being readable by a computer for executing the method of the invention. The invention further contemplates a machine-readable memory tangibly embodying a program of instructions executable by the machine for executing the method of the invention.

Likewise, although the embodiments have been described with particular reference to a store-and-forward mechanism, it is to be understood that this is by way of example only. There are advantages in exploiting the store-and-forward mechanism because it does not require recipients to be online when sending the messages and it obviates the need for presence awareness as is required in Push-to-Talk telephony. However, Push-to-Talk telephony is becoming increasingly popular and many cellular telephones are being provided with Push-to-Talk actuators and presence awareness. Such telephones may certainly be used to carry out the invention, so as to provide additional functionality as described.

The above description of illustrative, non-limiting embodiments has been given by way of an example. The above and other features of the invention including various novel method operations and a system and a device of the various novel components have been particularly described with reference to the accompanying drawings and pointed out in the claims. It will be understood that the particular process and construction of parts embodying the invention is shown by way of an illustration only and not as a limitation of the invention. The principles and features of this invention may be employed in varied and numerous embodiments without departing from the scope of the invention as defined by the appended claims and equivalents thereof.

1-9. (canceled)

10. A method for obtaining feedback from at least one recipient via a telecommunication network, the method comprising:
receiving from a sending device message data indicative of a recorded message that a sender device wishes to convey to a recipient device;
storing said message data together with a respective identity of each recipient device;
conveying data to each recipient device pertaining to said message data notification of awaiting message or could be message itself;
storing events relating to an activity performed by a recipient device on receiving or responding to said data;
analyzing said events so as to generate status data; and
storing the status data for access by the sender.

11. A computer program comprising computer program code means for performing the method of claim 10, when said program is run on a computer.

12. A computer program as claimed in claim 11 embodied on a computer readable medium.

13. A system for obtaining feedback from at least one recipient via a telecommunication network, the system including:
a communication device having a messaging client in bi-directional communication with a messaging server for receiving one or more events relating to a recipient receiving or responding to a media message sent by a communication device,
a Group Management Server storing definitions and properties of registered users and user groups of the system, and
a templates server for storing message templates for access by communication devices connected thereto.

14. The system according to claim 13, further comprising a presence server coupled to the protocol handler, to the messaging server and to the Group Management Server, said presence server operating in conjunction with an AB presence unit in the messaging client for providing properties of potential recipient devices.

15. The system according to claim 13, further comprising a location client operating in conjunction with a location server for allowing the location server to compile a list showing the location of each device.

16-19. (canceled)

20. A communication device for use with the system according to claim 13, for allowing a sending device to obtain feedback from at least one recipient device, said device comprising:
a processor,
a transmitter/receiver coupled to the processor for allowing wireless transmission and reception,
a message inbox providing a view of a subscriber inbox for each recipient on the messaging sever,
a memory for storing an address book and optionally sender/recipient profiles, and
a user interface allowing selection of one or more recipient addresses.

21. The communication device according to claim 20, further comprising:
a microphone/speaker driver for converting speech to electrical signals, and
a voice recording unit coupled to the microphone/speaker driver for recording the electrical signals.

22. (canceled)

23. The communication device according to claim 20, further including a presence awareness module for allowing a user to determine at a glance whether a receiving device is on-line and available for receiving a message.

24. The communication device according to claim 20, further including a template browser for accessing templates from the templates server.

25. The communication device according to claim 20, further including a template browser for accessing templates from the templates server.

26. The communication device according to claim 20, further including a display.

27. The communication device according to claim 26, further comprising:
a camera/display driver for capturing a video image, and
a video codec coupled to the camera/display driver for converting the video image to a video stream.

28. A messaging server for use with the system according to claim 13, for allowing a sending device to obtain feedback from at least one recipient device, said messaging server comprising:
a processor,
first and second interfaces coupled to the processor for coupling to respective first and second communication devices,
a memory coupled to the processor for storing message data, and
a data analysis unit coupled to the processor and being adapted to process data received from recipient device in response to messages conveyed thereto by a sender device.

29. The messaging server according to claim 28, further including a GLMS interface for allowing groups to be defined so that an incoming call directed to one member of the group may be automatically sent to the other members of the group.

30. The messaging server according to claim 28, wherein the memory stores icons or other image data of registered users.

31. The messaging server according to claim 28 for use with the system according to claim 14, further including a presence server interface for connection to the presence server.

32. The messaging server according to claim 28, further including a templates server interface for connection to the templates server.

33. The messaging server according to claim 28, for use with the system according to claim 14, further including a location server interface for connection to the location server.

34. The messaging server according to claim 28, wherein said memory provides storage for a plurality of subscriber inboxes each in respect of a different registered subscriber.
